(19) United States
(12) Patent Application Publication
(10) Pub. No.: US 2026/0268363 A1
(43) Pub. Date: Sep. 10, 2026

(54) CONTENT DELIVERY PLATFORM WITH CONFIGURABLE GAMIFICATION LOGIC

(71) Applicant: Apexis, Inc., dba Wonder, Tampa, FL (US)

(72) Inventors: Alexander Sher, Escondido, CA (US); Kaspar Fopp, Lutz, FL (US)

(73) Assignee: Apexis, Inc., dba Wonder, Tampa, FL (US)

(21) Appl. No.: 19/559,851

(22) Filed: Mar. 6, 2026

Related U.S. Application Data
(60) Provisional application No. 63/767,770, filed on Mar. 6, 2025.

(51) Int. Cl. G06Q 30/0226; G06F 18/24

(52) U.S. Cl. CPC G06Q 30/0226; G06F 18/24

(57) ABSTRACT

Embodiments of the invention are directed to systems, methods, and computer program products for processing network simulations. In some embodiments, the method includes ingesting a content dataset from one or more third party systems; processing the content dataset at a private server to generate a plurality of optimized content items; distributing one or more optimized content items to an end-point device, where the end-point device is configured to access the one or more optimized content items via an end-point application; monitoring at least one engagement metric associated with the one or more optimized content items; and executing a gamification logic module, where at least one output of the gamification logic module is based on the at least one engagement metric.

### TECHNOLOGICAL FIELD

Example embodiments of the present disclosure relate to a content delivery platform with configurable gamification logic.

### BACKGROUND

In conventional systems for incentive programming, incentive delivery or payout is typically delayed, as payouts must be verified against completed orders in a supplier system. Thus, there is a need for an in-system, virtual currency which can be pushed directly to an end user as a transaction is completed via a point-of-sale system, website, kiosk, and/or the like.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for providing a content delivery platform with custom gamification logic is presented. The system may include at least one non-transitory storage device and at least one processor coupled to the at least one non-transitory storage device, where the at least one processor is configured to: ingest a content dataset from one or more third party systems; process the content dataset at a private server to generate a plurality of optimized content items; distribute one or more optimized content items to an end-point device, wherein the end-point device is configured to access the one or more optimized content items via an end-point application; monitor at least one engagement metric associated with the one or more optimized content items; and execute a gamification logic module, wherein at least one output of the gamification logic module is based on the at least one engagement metric.

In some embodiments, the invention further includes generating aggregated data associated with the at least one output of the gamification logic module.

In some embodiments, ingesting the content dataset further comprises receiving the content dataset via a direct system integration with the one or more third party systems.

In some embodiments, ingesting the content dataset further comprises receiving the content dataset via a file upload from the one or more third party systems.

In some embodiments, the content dataset comprises at least one video file.

In some embodiments, ingesting a content dataset from one or more third party systems further comprises: extracting a set of metadata from the content dataset; applying a validation algorithm to the content dataset; and storing the content data and the set of metadata in a database.

In some embodiments, the validation algorithm comprises at least one of: a file integrity check, a content format validation process, and a compliance verification process.

In some embodiments, processing the content dataset at a private server to generate a plurality of optimized content items further comprises: using a generative artificial intelligence (AI) engine to generate one or more data tags associated with the plurality of optimized content items.

In some embodiments, the generative AI engine is further configured to generate at least one grouping of optimized content items.

In some embodiments, processing the content dataset at a private server to generate a plurality of optimized content items further comprises: applying an optimization algorithm to the content dataset, wherein the optimization algorithm is configured to prepare the content dataset for consumption at a mobile device.

In some embodiments, the optimization algorithm comprises at least one of: HLS encoding, video compression, and image compression.

In some embodiments, the invention further includes applying one or more filtering algorithms to the plurality of optimized content items; and predicting a relevance score of at least one optimized content item associated with at least one end-point user.

In some embodiments, the invention further includes refining the relevance score based on the at least one engagement metric.

In some embodiments, distributing the one or more optimized content items to the end-point device further comprises identifying the end-point device based on information received from the one or more third party systems.

In some embodiments, distributing the one or more optimized content items to the end-point device further comprises identifying the end-point device based on information received from the end-point device.

In some embodiments, the invention further includes generating a streaming queue associated with the end-point device.

In some embodiments, the invention further includes distributing at least a portion of the streaming queue to the end-point device.

In some embodiments, the invention further includes monitoring a content delivery status of the one or more optimized content items.

In some embodiments, monitoring the content delivery status of the one or more optimized content items further comprises monitoring an application programming interface (API) response code of the end-point device.

In some embodiments, the gamification logic module comprises a gamification rule defined by the one or more third party systems.

In some embodiments, the gamification rule comprises a triggering event associated with an end-point user.

In some embodiments, the gamification rule comprises a time-based event.

In some embodiments, the gamification logic module is further configured to define a virtual currency system.

In some embodiments, the end-point application is configured to display one or more notifications associated with the virtual currency system.

In some embodiments, the gamification logic module further comprises one or more redemption rules associated with the virtual currency system.

In some embodiments, the one or more redemption rules are based on data received from the one or more third party systems.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for a content delivery platform with custom gamification logic, in accordance with an embodiment of the disclosure;

FIG. 2 a block diagram illustrating the system providing a content delivery platform with custom gamification logic, in accordance with an embodiment of the present disclosure;

FIG. 3 illustrates an exemplary generative AI subsystem 300, in accordance with an embodiment of the disclosure; and

FIGS. 4A-4E illustrate process flows for a content delivery platform with configurable gamification logic, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “agentic AI,” “AI agent,” “agentic AI engine,” and/or similar variants may refer to an artificial intelligence module designed to execute a specific, well-defined task using a constrained dataset that is optimized for its designated function and, as used herein, may each be used interchangeably. An agentic AI engine may be trained to operate within a limited problem domain, leveraging task-specific inference mechanisms to generate precise outputs with minimal dependency on extraneous data or generalized AI models. The agentic AI engine may function autonomously within its assigned scope, producing outputs that can be utilized by an end-user, another system module, another agentic AI engine, and/or the like. In some embodiments, an agentic AI engine may incorporate adaptive learning mechanisms to refine task performance based on real-time feedback, subject to predefined operational constraints.

The present invention is directed to a software platform which operates as a gateway for supplier entities to deliver training content to individual users, as well as execute and manage incentive programs. The gateway operates in multiple directions, allowing supplier entities or other content creation entities to deliver content to recipients, as well as receive analytics and other reporting data which is aggregated from the end-point devices of the individual users. Reporting data may include information such as incentive program metrics and adherence data, content metrics and usage frequency, questions and feedback, as well as any other relevant reporting data.

In conventional software-based systems for incentive programs, incentive delivery or payout is typically delayed, as payouts must be verified against completed orders in a supplier system. To address this problem, the present invention provides an in-platform, virtual currency which can be pushed directly to an end user as a transaction is completed via a point-of-sale system, website, kiosk, and/or the like. This allows a user to receive an incentive or payout immediately upon completion of a transaction. Then, once a transaction is verified against a supplier system, the virtual currency may be exchanged for real-world currency and/or other incentives.

Furthermore, the platform may be configurable such that any end-point entity may customize the platform for a specific set of end-point users. Within the configurations set by an end-point entity, each end-point user may be further able to configure the platform in order to access and interact with a variety of available supplier content, as well as manage in-platform incentives and virtual currency. In some embodiments, the platform may include gamification logic such as shared leaderboards, personal analytics (e.g., goals, challenges, trackers, and/or the like), interactive surveys and quizzes, customizable incentive delivery, and/or the like.

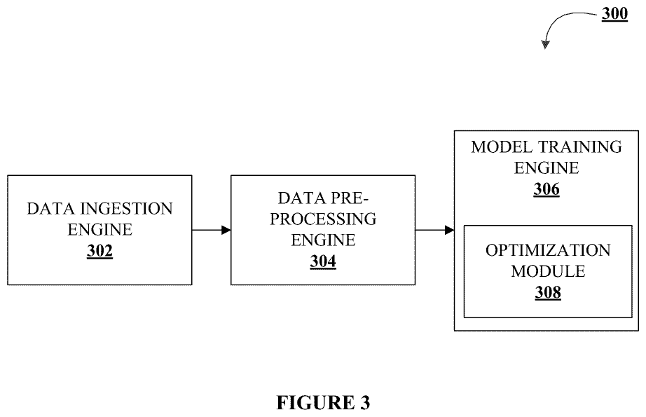

In some embodiments, the platform may further include an embedded generative artificial intelligence (AI) engine as described in greater detail with respect to FIG. 3. The generative AI engine may be integrated with a camera and/or microphone device of an end-point device, providing for real-time conversation analysis. By combining real-time conversation analysis and integration with supplier inventory systems, the generative AI engine may be configured to generate and present recommended dialogues, services, action, and products to the end user.

In an embodiment, the present invention includes a data aggregation and unification platform. The data aggregation and unification platform may be configured to cleanse and standardize product contract data, as well as ingest product catalogs, pricing, and inventory feeds offered by manufacturers in order to act as a central data repository. Additionally, the platform may be configured to apply versioning on top of existing product schema, as well as maintain multiple product names that can be used across multiple distribution channels. The platform may further use an API interface to provide end-point users with access to both view and export catalogs, pricing options, and inventory data. In some embodiments, the platform may use the integrated generative AI engine to detect anomalies, automatically onboard catalog data, generate three-dimensional or other visual materials, and automatically create variant groups and apply object detection logic.

In an embodiment, the present invention may further include an end-user-facing software application, which may integrate with existing point-of-sale and other merchant systems. The end-user-facing software application may support product record management, and may be further integrated with a fulfillment or delivery service entity in order to track fulfilment statuses. The software application may allow an end user to export product data from the data aggregation and unification platform, as well as import sales data to the data aggregation and unification platform. In some embodiments, the software application may be configured to allow an end user to access the features and functions of the data aggregation platform, such as applying versioning to product schema and managing custom variant groups of products.

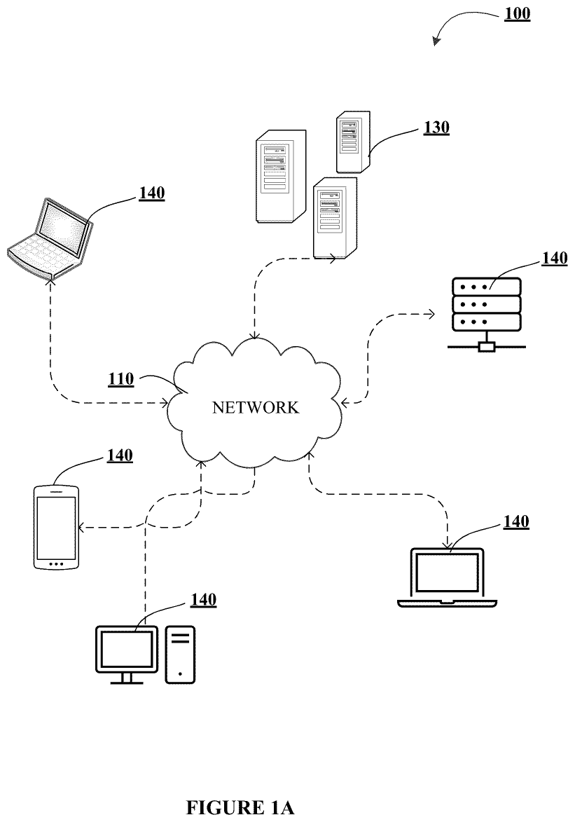

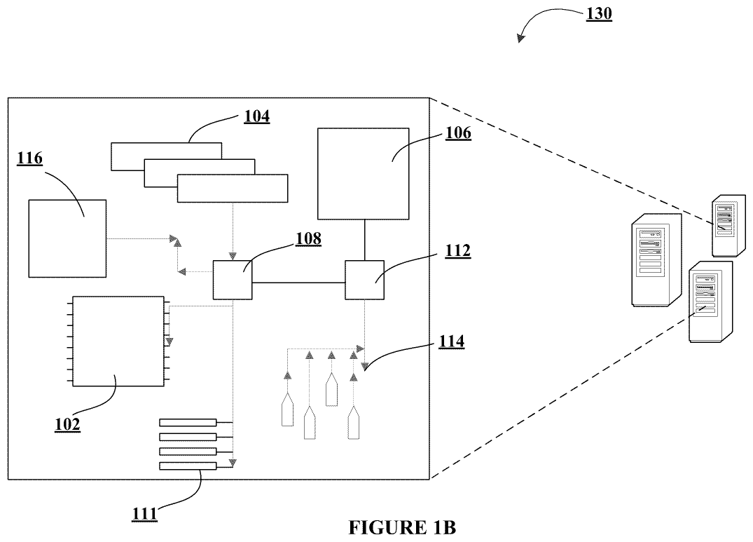

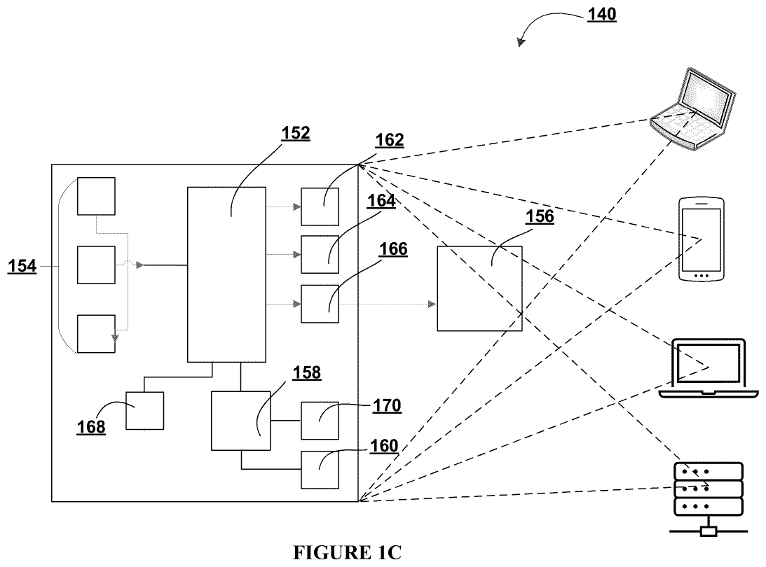

FIGS. 1A-1C illustrate technical components of an exemplary distributed computing environment 100 for the processes described herein, in accordance with an embodiment of the disclosure. As shown in FIG. 1A, the distributed computing environment 100 contemplated herein may include a system 130, an end-point or network device(s) 140, and a network 110 over which the system 130 and end-point or network device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

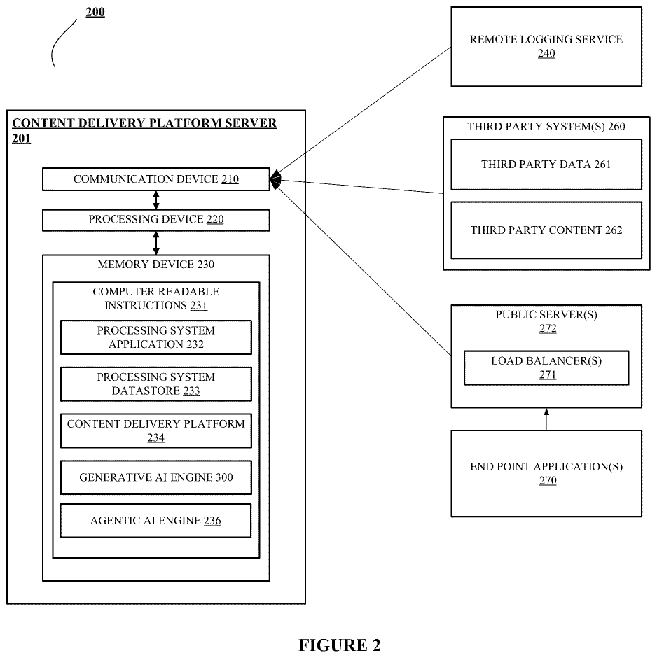

FIG. 2 illustrates a block diagram of a content delivery platform 200, in accordance with an embodiment of the present disclosure. As illustrating in FIG. 2, the content delivery platform 200 may comprise a content delivery platform server 201, which may be hosted on a private server, as well as one or more public servers 272 and one or more end-point applications 270. The private server 201 may comprise a computing instance hosted within a restricted-access virtual private cloud, and may be configured to process data and execute logic, with access restricted to internal network entities. Thus, the private server 201 may not have a publicly accessible IP address and may be secured by a network access control list, VPN tunnel, and/or the like. The private server 201 may be configured to communicate with the public server(s) 272 via an internal, encrypted connection (e.g. TLS, IPsec, and/or the like).

The public server(s) 272 may comprise one or more computing instances with network configurations that allow external access via a publicly routable IP address or domain name. Each public server 272 may comprise an API load balancing component 271, which may be configured to distribute incoming traffic from the end-point application(s) 270 based on a set of predetermined rules, such as request type, server load, geographic proximity, and/or the like.

The end-point application(s) 270 may comprise a native application, web-based application, Progressive Web App (PWA), or the like, configured to run in a web browser of an end-point device or natively in an end-point device. The end-point application(s) 270 may be configured to transmit requests to access or modify data, which are routed to the one or more API load balancing components 271 of the public server(s) 272. The API load balancing components 271 may then perform authentication and authorization of the request, as well as apply routing logic to the request. In some embodiments, the routing logic may result in the request being routed to a container and/or task manager of the public server 270 (for example, an Elastic Container Service (ECS) cluster), which may be configured to execute one or more logical processes via containerized services. Additionally or alternatively, the routing logic may result in the request being routed to the private server 201, which may be configured to perform backend logic via a processing system application 232, generative AI engine 300, and/or the like. In some embodiments, the private server 201 may be further to configured to securely communicate with one or more third-party private servers 260, for example, to access third party data 261 and/or third party content 262. The private server 201 may also securely communicate with a remote logging and monitoring service 240 configured to monitor response times, container health, security events, and/or the like. In some embodiments, the logging and monitoring service 240 may be fully integrated within the private server 201.

In some embodiments, the private server 201 may include at least a communication device 210, a processing device 220, and a memory device 230 having a generative AI engine 300, a processing system application 232, a processing system datastore 233, a content delivery platform module 234, and an agentic AI engine 236 stored therein. As shown, the processing device 220 is operatively connected to and is configured to control and cause the communication device 210 and the memory device 230 to perform one or more functions. In some embodiments, the generative AI engine 300, the content delivery platform module 234 and/or the processing system application 250 comprise computer readable instructions 231 that when executed by the processing device 220 cause the processing device 220 to perform one or more functions and/or transmit control instructions to other systems, applications, and/or devices in the system environment 100. It will be understood that the generative AI engine 300, the content delivery platform module 234 and/or the processing system application 232 may be executable to initiate, perform, complete, and/or facilitate one or more portions of any embodiments described and/or contemplated herein. In some embodiments, the private server 201 may be configured to silo third party data 261 and/or third party content 262 within the content delivery platform module 234, agentic AI engine 236, and generative AI engine 300 such that data and/or content from a first third party system remains segregated from data and/or content from a second third party system. Thus, each instance of the end-point application 270 may be configured to be associated with a particular third party system 260 such that only data and/or content from the particular third party system 260 is accessible via the end-point application 270.

The communication device 210 may generally include a modem, server, transceiver, and/or other devices for communicating with other devices on the network 101. The communication device 210 may be a communication interface having one or more communication devices configured to communicate with one or more other devices on the network 101.

Additionally, the processing device 220 may generally refer to a device or combination of devices having circuitry used for implementing the communication and/or logic functions hosted within the private server 201. For example, the processing device 220 may include a control unit, a digital signal processor device, a microprocessor device, and various analog-to-digital converters, digital-to-analog converters, and other support circuits and/or combinations of the foregoing. Control and signal processing functions of the private server 201 may be allocated between these processing devices according to their respective capabilities. The processing device 220 may further include functionality to operate one or more software programs based on computer-executable program code 231 thereof, which may be stored in a memory device 230, such as the processing system application 232 and the content delivery platform module 234. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 220 may be configured to use the network communication interface of the communication device 210 to transmit and/or receive data and/or commands to and/or from the other devices/systems connected to the network 101.

The memory device 230 within the private server 201 may generally refer to a device or combination of devices that store one or more forms of computer-readable media for storing data and/or computer-executable program code/instructions. For example, the memory device 230 may include any computer memory that provides an actual or virtual space to temporarily or permanently store data and/or commands provided to the processing device 220 when it carries out its functions described herein. As used herein, memory may include any computer readable medium configured to store data, code, or other information. The memory device 230 may include volatile memory, such as volatile Random Access Memory (RAM) including a cache area for the temporary storage of data. The memory device 230 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the content delivery platform 200 performing one or more steps described herein in conjunction with other devices and systems, either automatically based on executing computer readable instructions of the memory device 230, or in response to receiving control instructions from another device in the system environment 100. In some instances, the system refers to the devices and systems on the system environment 100 of FIG. 1. The features and functions of various embodiments of the invention are be described below in further detail. It is understood that the servers, systems, and devices described herein illustrate one embodiment of the invention. It is further understood that one or more of the servers, systems, and devices can be combined in other embodiments and still function in the same or similar way as the embodiments described herein.

FIG. 3 illustrates an exemplary generative AI subsystem 300, in accordance with an embodiment of the invention. The generative AI subsystem 300 may include a data ingestion engine 302, a data pre-processing engine 304, and a model training engine 306. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 302 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 300 may utilize one or more machine learning techniques to generate new content. In machine learning, the quality of data and the useful information that may be derived therefrom directly affects the ability of the machine learning model to learn. The data pre-processing engine 304 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that may be suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training engine 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data may be used to update the model's parameters, while the validation and testing datasets may be reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

Additional or alternative embodiments of image generation models may include three-dimensional (3D) image generation models configured to generate 3D materials and files from two-dimensional files (e.g., image files, video files, etc.). During training of a 3D image generation model, the model training engine 306 may employ feature detection and/or feature extraction using architectures such as Convolutional Neural Networks (CNNs), Deformable Convolutional Neural Networks (DCNNs), ViTs (as described previously), and/or the like. Using one or more depth estimation models, the model training engine 306 may be configured to predict height maps (e.g., surface details) of a two-dimensional image, and may apply adversarial training techniques to continuously improve the model's ability to predict (e.g., fill in) missing depth information. Additional rendering techniques (e.g., physics-based rendering (PBR), Spatially Varying Bidirectional Reflectance Distribution Function (SVBRDF) models, texture synthesis techniques, etc,) may be employed to extract additional information and properties from the two-dimensional file, such as reflectance, roughness, and/or the like. The 3D image generation models may be further trained using the model training engine 306 to output the extract information as a set of one or more maps (e.g., height maps, albedo maps, texture maps, etc.) configured to be input into a 3D modeling software (e.g., Blender, Substance Painter, Unity, etc.).

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306, which includes an optimization module 308, may implement various optimization techniques to improve model performance and efficiency. The optimization module 308 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting various parameters which influence the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation. In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

In some embodiments, the generative AI subsystem 300 may further integrate with an agentic AI engine (e.g., the agentic AI engine 236) to enable autonomous interaction, decision-making, and task execution capabilities based on the outputs generated by the underlying generative models. In such embodiments, the agentic AI engine may serve as a higher-order orchestration layer that interprets, contextualizes, and acts upon the generative outputs, effectively bridging the gap between static generation and autonomous action. For instance, in the context of a large language model (LLM), the agentic AI engine may evaluate inputs received from an end-point application in real-time and determine appropriate follow-up actions, such as initiating a database query, interacting with a third-party API, generating and displaying a textual response, and/or the like.

To facilitate these capabilities, the agentic AI engine may include various submodules, such as a task planning module, an environment interaction module, a goal evaluation module, and a feedback refinement module. The task planning module may parse user input or contextual prompts received from the end-point application to derive discrete objectives and formulate execution strategies based on available capabilities. The environment interaction module may monitor external system states, receive real-time data inputs, and interact with surrounding digital environments (e.g., APIs, user interfaces, or sensor networks). The goal evaluation module may assess whether generated content or performed actions align with user-defined or system-inferred goals, leveraging reinforcement signals or heuristic scoring systems. In embodiments where outputs require refinement or exhibit ambiguity, the feedback refinement module may prompt the generative AI subsystem 300 to regenerate or modify outputs, thereby ensuring outputs are coherent, actionable, and goal-conformant.

In some embodiments, the agentic AI engine may leverage a policy engine to enforce user-defined constraints, value considerations, operational protocols, or gamification logic. This policy engine may operate in tandem with the generative AI models to evaluate whether generated content adheres to predetermined rulesets before execution or dissemination. For example, depending on a particular user type of an instance of the end-point application (e.g., administrator, end user, or the like), a generated response may be evaluated against compliance rules or escalation protocols to determine whether it may be delivered directly or requires additional oversight. In other applications, the policy engine may act as a gatekeeper that either approves or modifies AI-generated recommendations based on regulatory, organizational, or safety standards.

The agentic AI engine may also incorporate contextual memory systems that allow it to retain and reference historical interactions, learned preferences, or environmental cues. These memory systems may take the form of dynamic knowledge graphs, session-specific memory stores, or long-term memory embeddings trained through continual learning strategies. By maintaining such context over time, the agentic AI engine may generate more personalized, consistent, and contextually relevant responses, improving its efficacy in domains requiring continuity and situational awareness, such as virtual assistants, autonomous negotiation agents, or adaptive tutoring systems. This capacity to both generate and act with contextual understanding effectively distinguishes the generative AI subsystem 300, when incorporated with an agentic AI engine, from conventional generative systems.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

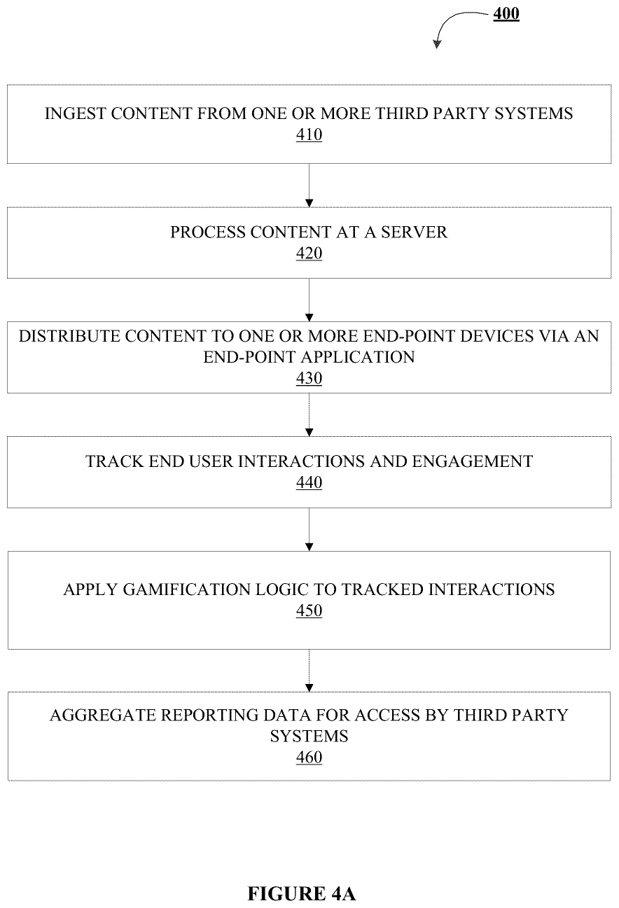

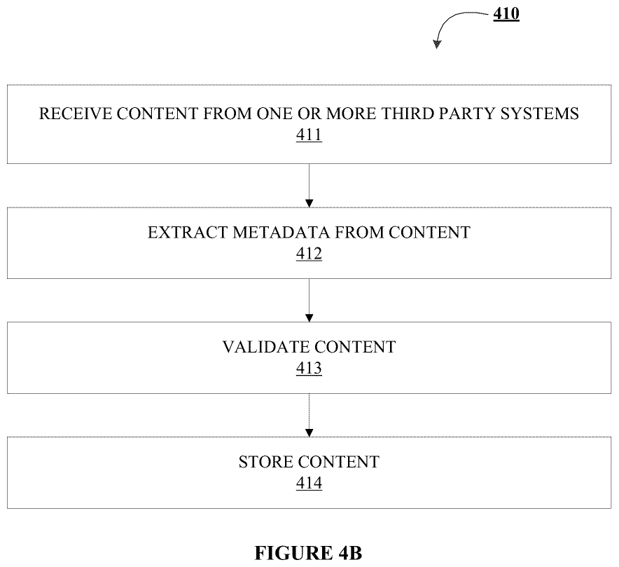

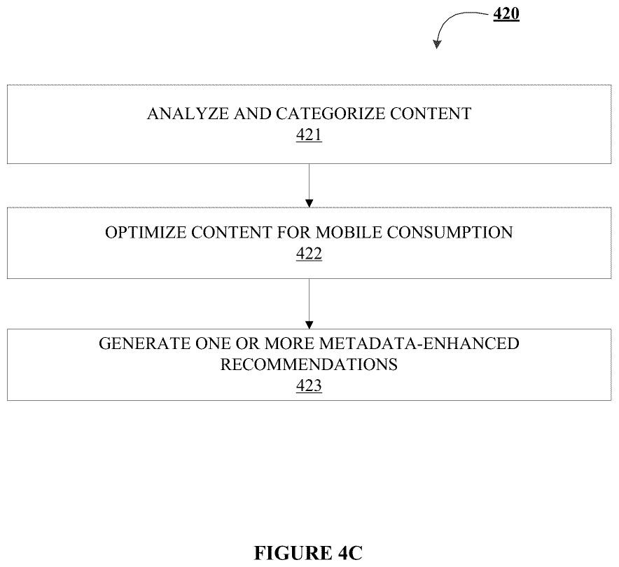

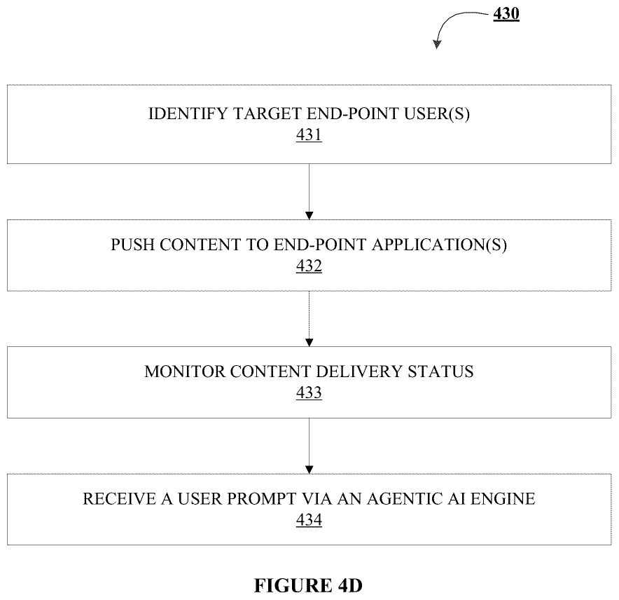

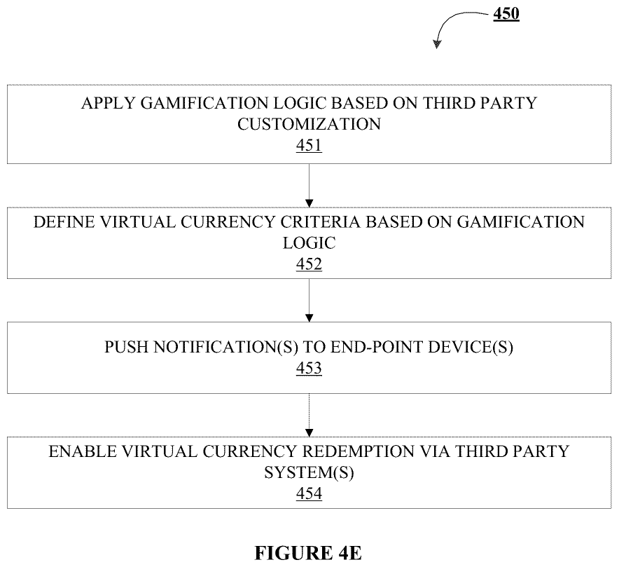

FIG. 4A illustrates a high-level process flow 400 for a content delivery platform with configurable gamification logic, in accordance with an embodiment of the disclosure. FIGS. 4B-4E illustrate sub-process flows for the content delivery platform, in accordance with additional or alternative embodiments of the disclosure. The high-level process flow 400 may begin at block 410, where the system is configured to ingest content from one or more third party systems or servers. Then, at block 420, the system may be configured to apply one or more data processing steps to process the received content at a private server. Next, at block 430, the system may distribute the processed content to one or more end-point devices operating an end-point application, such as a native application, web-based application, PWA, or the like. In some embodiments, the system may actively push content to the end-point devices. Additionally or alternatively, the end-point device(s) may access the content in response to a request or query to the private server.

Sequentially or simultaneously, the system may, at block 440, continuously track end user interactions and engagement with the distributed content. For example, in some embodiments, the system may use an event-driven architecture to capture real-time user interactions at the end-point applications. For example, the system may monitor and capture content consumption data (e.g., video views, start times, pause times, completion rates, and/or the like), social engagement (e.g., likes, comments, shares, and/or the like), navigation events (e.g., scroll depth, clicks, time spent on page, and/or the like), and other interactive events (e.g., interactions with quizzes, games, surveys, and/or the like). In some embodiments, the system may track user interactions via background processing, followed by batch uploads to the private server, in order to reduce the network load. In some embodiments, user interactions at the end-point applications may be captured as inputs to the agentic AI engine. At the private server, the system may then analyze the collected event data. For example, in some embodiments, the system may be configured to generate personalized content recommendations (e.g., using the features of the generative AI subsystem), apply A/B testing to monitor content performance, tailor gamification logic as described in greater detail with respect to FIG. 4D, apply predictive modeling to predict future engagement trends, and/or the like.

The process flow may then continue to block 450, where the system may apply gamification logic to the tracked end-user interactions. In some embodiments, the gamification logic may be configurable by one or more third party system(s) as is described in greater detail with respect to FIG. 4E. Finally, the process flow may conclude at block 460, where the system may aggregate reporting data for access by the third-party system(s). For example, in some embodiments, the system may utilize an API endpoint to allow the third-party system(s) to access real-time analytic data and dynamically adjust gamification logic based on engagement metrics associated with the real-time analytic data. Additionally or alternatively, the system may allow the third-party system(s) to access bulk data exports (e.g., CSV data exports) to provide for offline review at the third-party system(s).

FIG. 4B illustrates a sub-process flow for block 410 of the high-level process flow 400, in accordance with an embodiment of the disclosure. The sub-process flow may begin at block 411, where the system is configured to receive content from one or more third party systems. In some embodiments, the system may be configured to receive the content via an end-point API, file upload, and/or direct system integration. The content may include any data or content such as product data (e.g., specifications, images, SKU data, and/or the like), inventory data, sales data, training materials (e.g., videos, quizzes, and/or the like), and/or any other data or content exchanged between manufacturers, suppliers, merchants, and end consumers. In some embodiments, the content may comprise training materials in the form of video files accompanied by video metadata (e.g., JSON-formatted data and/or the like). Upon successful receipt of content from the third-party systems, the system may be configured to provide the third-party systems with a notification indicating the successful receipt of content.

The sub-process flow may then continue to block 412, where the system is configured to extract metadata from the received content. For example, in some embodiments, the system may extract fields such as titles, descriptions, content types, timestamps, creator information, data tags, and/or the like. The process flow may then continue to block 413, where the system is configured to validate the received content by executing one or more file integrity checks, content format validation processes, compliance verification processes, and/or the like.

The sub-process flow may then conclude at block 414, where the system is configured to store the received content in the private server or at another cloud-based object storage location. In some embodiments, the content may be indexed by a content ID, category, creator information, data tag, and/or the like. Additionally or alternatively, the extracted metadata may be stored alongside the content and/or may be stored in a metadata database (e.g., an SQL database) in order to provide for rapid querying and content retrieval.

FIG. 4C illustrates a sub-process flow for block 420 of the high-level process flow 400, in accordance with an embodiment of the disclosure. The sub-process flow may begin at block 421, where the system is configured to analyze and categorize the received content. For example, in some embodiments, the system may be configured to use the generative AI engine 300 to generate tags and keywords associated with the stored content in order to enhance searchability and enable more rapid content access. Additionally or alternatively, the system may be configured to use the generative AI engine 300 to create content groups and subgroups, such as sequential video series, series of videos followed by particular quizzes or interactive elements, and/or the like.

The sub-process flow may then continue to block 422, where the system is configured to optimize the content for mobile consumption. For example, in some embodiments, the system may be configured to apply HLS encoding to video content in order to enable adaptive bitrate streaming, which may allow for smoother video playback at an end-point device regardless of network bandwidth fluctuations. Additionally or alternatively, to minimize network bandwidth requirements, the system may be configured to apply image and/or video compression algorithms to the stored content. In some embodiments, the system may use the generative AI engine 300 to automatically generate subtitles and/or closed captioning associated with stored video content.

The sub-process flow may then continue to block 423, where the system is configured to generate one or more metadata-enhanced recommendations based on the content. For example, in some embodiments, the system may be configured to apply one or more filtering algorithms to predict a relevance score of stored content for a particular end-point user and/or category of end-point users. In another example, in some embodiments, the system may be configured to continuously apply and refine content scoring based on received engagement data such as engagement history, user interaction data, and/or the like. Then, as content scoring is dynamically updated, the system may update content tags to allow for more rapid querying of high-performing content.

FIG. 4D illustrates a sub-process flow for block 430 of the high-level process flow 400, in accordance with an embodiment of the disclosure. The sub-process flow may begin at block 431, where the system is configured to identify one or more target end-point users associated with a particular category of stored content. In some embodiments, target end-point users may be pre-identified and segmented based on information received from one or more third party systems, and/or information received from one or more end-point devices. For example, in some embodiments, a third party system may assign a particular content item to all end-point users associated with a particular merchant system. In another example, a third party system may assign a second content item to all end-point users who have completed a set interaction with a first content item. In some embodiments, target end-point users may be associated with a particular user type (e.g., administrator, merchant representative, end-point consumer, and/or the like).

The sub-process flow may then continue to block 432, where the system is configured to push content to one or more end-point application(s). In some embodiments, the system may be configured to dynamically generate a personalized content feed for an end-user, such that as a first piece of content is delivered to the end-point device, a subsequent piece of content is added to a streaming queue. Additionally or alternatively, at least some portion of a streaming queue may be preloaded to the end-point user device in order to ensure a more seamless playback experience as network bandwidth fluctuates. In some embodiments, the system may generate push notifications informing an end-point user when new content is available for delivery.

The sub-process flow may then continue to block 433, where the system is configured to monitor a content delivery status of the on-demand content. For example, in some embodiments, the system may utilize a logging system to track, in real time, successful, pending, and/or failed content deliveries. Additionally or alternatively, the system may monitor API response codes for errors indicating that content delivery has failed. After determining that a content delivery has failed, the system may display a notification on the end-point device and/or may re-attempt to deliver the content.

In some embodiments, the sub-process flow may then continue to block 434, where the agentic AI engine is configured to receive one or inputs in the form of a user prompt at the end-point device. In some embodiments, the user prompt may comprise an unstructured text input, and the agentic AI engine may be configured to apply one or more natural language processing techniques to parse the unstructured text input, thus deriving one or more discrete objectives associated with the user prompt. The agentic AI engine may then be configured to formulate and execute one or more execution strategies based on available capabilities at the private server. For example, an execution strategy may comprise generating and displaying a text-based response at the end-point device, accessing a particular content piece and delivering the content to the end-point device, communicating with one or more third-party systems, and/or the like.

FIG. 4E illustrates a sub-process flow for block 450 of the high-level process flow 400, in accordance with an embodiment of the disclosure. The sub-process flow may begin at block 451, where the system is configured to execute gamification logic based on one or more third-party customizations. For example, in some embodiments, the third-party systems may access a gamification API of the system, which may allow users of the third-party system to define custom gamification rules associated with the third-party content and/or third-party data. For example, a third party system may define custom achievements, challenges, rewards, and/or the like which may be presented to an end-point user. A third-party system may further define custom event hooks, causing the system to trigger gamification events when an end-point user engages with particular content or completes a specific series of interactions (e.g., earning a set number of points after watching a specific video series and completing a quiz). Furthermore, the third party system may further define specific gamification logic, such as setting point allocation rules, time-based gamification events, and tiered incentive structures.

The process flow may then continue to block 452, where the system is configured to define a virtual currency based on the gamification logic customizations set by the one or more third-party systems. For example, the system may be configured to define and award end-point users one or more points associated with the virtual currency based on specific engagement data associated with the end-point user. In some embodiments, the system may further define, based on the gamification logic, one or more redemption rules, which may be validated via authentication tokens, smart contracts, or other transparent verification methods.

The process flow may then continue to block 453, where the system is configured to deliver one or more notifications to the one or more end-point application(s). For example, the system may be configured to deliver push notifications to the end-point application(s) based on changes to the gamification logic (e.g., new challenges, content availability, and/or the like). The one or more end-point application(s) may further display a virtual currency tracking dashboard, virtual currency leaderboards, and/or the like.

The process flow may then continue to block 454, where the system is configured to enable virtual currency redemption via one or more third-party system(s). For example, in some embodiments, the system may integrate the gamification logic with data received from third-party systems (e.g., inventory data, sales data, and/or the like) in order to enable virtual currency redemption based on one or more real-world events.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for providing a content delivery platform with custom gamification logic, the system comprising:
at least one non-transitory storage device; and
at least one processor coupled to the at least one non-transitory storage device, wherein the at least one processor is configured to:
ingest a content dataset from one or more third party systems;
process the content dataset at a private server to generate a plurality of optimized content items;
distribute one or more optimized content items to an end-point device, wherein the end-point device is configured to access the one or more optimized content items via an end-point application;
monitor at least one engagement metric associated with the one or more optimized content items; and
execute a gamification logic module, wherein at least one output of the gamification logic module is based on the at least one engagement metric.

2. The system of claim 1, wherein processing the content dataset at a private server to generate a plurality of optimized content items further comprises:
using a generative artificial intelligence (AI) engine to:
generate one or more data tags associated with the plurality of optimized content items; and
generate at least one grouping of optimized content items.

3. The system of claim 1, wherein processing the content dataset at a private server to generate a plurality of optimized content items further comprises:
applying an optimization algorithm to the content dataset, wherein the optimization algorithm is configured to prepare the content dataset for consumption at a mobile device.

4. The system of claim 1, wherein the at least one processing device is further configured to:
apply one or more filtering algorithms to the plurality of optimized content items; and
predict a relevance score of at least one optimized content item associated with at least one end-point user.

5. The system of claim 1, wherein the at least one processing device is further configured to:
generate a streaming queue associated with the end-point device; and
distribute at least a portion of the streaming queue to the end-point device.

6. The system of claim 1, wherein the at least one processing device is further configured to:
receive one or more user prompts from the end-point device; and
process the one or more user prompts via an agentic AI engine.

7. The system of claim 1, wherein the gamification logic module is further configured to define a virtual currency system.

8. The system of claim 7, wherein the gamification logic module further comprises one or more redemption rules associated with the virtual currency system.

9. A computer program product for providing a content delivery platform with custom gamification logic, the computer program product comprising a non-transitory computer-readable medium comprising code causing an apparatus to:
ingest a content dataset from one or more third party systems;
process the content dataset at a private server to generate a plurality of optimized content items;
distribute one or more optimized content items to an end-point device, wherein the end-point device is configured to access the one or more optimized content items via an end-point application;
monitor at least one engagement metric associated with the one or more optimized content items; and
execute a gamification logic module, wherein at least one output of the gamification logic module is based on the at least one engagement metric.

10. The computer program product of claim 9, wherein processing the content dataset at a private server to generate a plurality of optimized content items further comprises:
using a generative artificial intelligence (AI) engine to:
generate one or more data tags associated with the plurality of optimized content items; and
generate at least one grouping of optimized content items.

11. The computer program product of claim 9, wherein processing the content dataset at a private server to generate a plurality of optimized content items further comprises:
applying an optimization algorithm to the content dataset, wherein the optimization algorithm is configured to prepare the content dataset for consumption at a mobile device.

12. The computer program product of claim 9, wherein the apparatus is further configured to:
apply one or more filtering algorithms to the plurality of optimized content items; and
predict a relevance score of at least one optimized content item associated with at least one end-point user.

13. The computer program product of claim 9, wherein the apparatus is further configured to:
generate a streaming queue associated with the end-point device; and
distribute at least a portion of the streaming queue to the end-point device.

14. The computer program product of claim 9, wherein the apparatus is further configured to:
receive one or more user prompts from the end-point device; and
process the one or more user prompts via an agentic AI engine.

15. The computer program product of claim 9, wherein the apparatus is further configured to define a virtual currency system.

16. The computer program product of claim 15, wherein the gamification logic module further comprises one or more redemption rules associated with the virtual currency system.

17. A computer-implemented method for providing a content delivery platform with custom gamification logic, the method comprising:
ingesting a content dataset from one or more third party systems;
processing the content dataset at a private server to generate a plurality of optimized content items;
distributing one or more optimized content items to an end-point device, wherein the end-point device is configured to access the one or more optimized content items via an end-point application;
monitoring at least one engagement metric associated with the one or more optimized content items; and
executing a gamification logic module, wherein at least one output of the gamification logic module is based on the at least one engagement metric.

18. The method of claim 17, further comprising:
generating a streaming queue associated with the end-point device; and
distributing at least a portion of the streaming queue to the end-point device.

19. The method of claim 17, further comprising:
receiving one or more user prompts from the end-point device; and
processing the one or more user prompts via an agentic AI engine.

20. The method of claim 17, wherein the gamification logic module is further configured to define a virtual currency system and one or more redemption rules associated with the virtual currency system.
